(19) United States
(12) Patent Application Publication
(10) Pub. No.: US 2010/0266728 A1
(43) Pub. Date: Oct. 21, 2010

(54) TINGLING TRIGEMINAL COMPOSITION

(75) Inventors: David Philippe Labbe, Lausanne (CH); Celine Riera, Lausanne (CH); Gaelle Marie Laure Schlup-Ollivier, Lausanne (CH); Johannes Le Coutre, Pully (CH)

Correspondence Address: K&L Gates LLP, P.O. Box 1135, CHICAGO, IL, 60690, US

(73) Assignee: NESTEC S.A., Vevey (CH)

(21) Appl. No.: 12/742,362

(22) PCT Filed: Nov. 13, 2008
(86) PCT No.: PCT/EP2008/065475

§ 371 Date: May 11, 2010

(30) Foreign Application Priority Data
Nov. 15, 2007 (EP) 07120825.0

(51) Int. Cl. A23L 1/22; A23L 2/56

(52) U.S. Cl. 426/66; 426/538

(57) ABSTRACT

The present invention relates to all-natural tingling compositions, to the use thereof in food products, in particular in frozen food or chilled dairy products and to a method for producing said tingling compositions.

### FIELD OF THE INVENTION

The present invention relates to all-natural tingling compositions, to the use thereof in food products, in particular in frozen food and chilled dairy products and to a method for producing said tingling compositions.

### BACKGROUND OF THE INVENTION

A plethora of compounds (plant extracts or synthetic compounds) are known in the art to provide a tingling trigeminal perception and are used accordingly in a number of food products. Such plant extracts include extracts from pepper, onion, garlic, radish, horseradish, mustard, chili, ginger etc. These may more precisely include, but are not limited to: Jambu Oleoresin or para cress (Spilanthes sp.) in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al.

US2004/0241312 describes the use of trans-pelletorin as a compound providing a salivating and/or prickly effect. Although the compound may be extracted from natural products, it is preferably synthesised as to avoid undesired taste arising from the natural products. Examples of products comprising said compound are toothpaste, mouthwash, chewing gum, seasoning for snack foods, cracker cream filling.

### OBJECT OF THE INVENTION

It is thus an object of the invention to provide an all natural tingling trigeminal composition which can be used in a variety of food products.

### SUMMARY OF THE INVENTION

Accordingly, the present invention relates, in a first aspect, to a tingling trigeminal composition comprising Sichuan pepper extract and cinnamaldehyde in a ratio of 1:0.005 to 1:0.01, preferably 1:0.008.

In a second aspect, the invention also concerns a frozen food or chilled dairy composition comprising the tingling trigeminal composition of the invention.

The use of Sichuan pepper extract and cinnamaldehyde in the production of a tingling trigeminal composition thus also forms part of the invention.

Finally, a method for the production of a tingling trigeminal composition comprising the steps of
a. Providing a Sichuan pepper extract and
b. Mixing the Sichuan pepper extract in a solution of cinnamaldehyde
   is also encompassed by the present invention.

### FIGURES

The present invention is described hereinafter with reference to some embodiments shown in the figures wherein

FIG. 1 shows the tingling intensity scoring over a 600 second period after consumption of a Sichuan aqueous solution at 125 ppm by temporal dominance of sensations (TDS). This descriptive sensory method consists in assessing iteratively over time until the sensations ends, which sensation is dominant (meaning the most intense sensation) and in scoring its intensity (Bornes, F., Hidrio, C., Fernandes, A., Aubry, V., Comparison between Temporal Dominance of Sensations and Time Intensity results, Food Quality and Preference (2007), doi: 10.1016/j.foodqua1.2007.06.012.)

FIG. 2 shows the tingling intensity scoring over a 600 second period after consumption of a cinnamaldehyde aqueous solution at 1 ppm by temporal dominance of sensations (TDS) (see above),

FIG. 3 shows the tingling intensity scoring over a 600 second period after consumption of a Sichuan and cinnamaldehyde aqueous solution with a ratio of 1:0.008 by temporal dominance of sensations (TDS) (see above) and

FIG. 4 shows the impact of sichuan, cinnamaldehyde and the combination of both on the activity of receptors responsible for tingling perception (from the TRP family range of receptors involved in trigeminal perceptions). Receptor activity is quantified in terms of calcium influx intensity. The higher the calcium influx is, the stronger the receptor is activated and therefore the more intense the tingling perception is perceived.

### DETAILED DESCRIPTION OF THE INVENTION

The present invention relates to a tingling trigeminal composition. By “tingling” is to be understood a prickly, spicy, slightly numbing effect felt upon consumption of a product.

The tingling perception arises upon consumption by stimulation of cell receptors involved in trigeminal perception and responsible for tingling perceptions. Measure of the tingling intensity at receptor level can be determined by the appropriate bio molecular technique. Cells expressing tingling sensing receptors (TRPA1) and burning sensing receptors (TRPV1) were engineered. Functional assays, measuring the increase of intracellular calcium levels were performed to quantify receptors activity by the tingling mixture.

These assays allowed to determine the optimum concentration for Sichuan extract with high tingling effect versus low burning effect. They also allow to quantify the synergistic effect between cinnamaldehyde and Sichuan extract at the TRPA1 receptor level.

The present invention provides a new tingling trigeminal composition comprising Sichuan (also written Szechuan) pepper extract and cinnamaldehyde in a ratio of 1:0.005 to 1:0.01, preferably 1:0.008.

By “Sichuan pepper extract” is meant the extracts resulting from a cold extraction with an organic solvent such as hexane, of the outer pod of the tiny fruit of a number of species in the genus Zanthoxylum (e.g. Zanthoxylum piperitum, Zanthoxylum americanum etc.). These extracts include alpha-, beta-, gama-sanshool, hydroxy sanshool, flavonoids, terpenes, benzophenthedin alkaloids, xanthoxylin, sesamin, limonene, citronellol, essential oils etc. Preferably, the extract is in the form of an oleoresin.

Sichuan pepper has been used in the past, e.g. it has been listed in some prior art Asian recipes. However, up-to date the pepper has only been used in a processed, e.g. cooked form, which presents the drawback of denaturing some properties of the ingredient. The extract used according to the present invention, prepared via a cold extraction process is in a form that has proven to provide unexpected trigeminal perceptions when used in the combination here-disclosed.

Cinnamaldehyde is obtainable commercially and is a commonly used flavouring ingredient. According to the present invention, cinnamaldehyde is used in such proportions that it does not impart a taste or olfactory perception to the end composition to which it is added, but only triggers a trigeminal tingling perception when combined with the Sichuan pepper extract.

It has thus now been found that a combination of Sichuan pepper extract and cinnamaldehyde in a specific ratio provides a tingling trigeminal composition which is longer lasting and more intense than compositions comprising Sichuan pepper extract alone or cinnamaldehyde alone. The synergistic effect of the present combination is shown on FIGS. 1 to 3.

Referring to FIGS. 1 to 3, TDS data were represented by curves corresponding to the percentage of subjects who selected the attribute among the three (Tingling, Bitter and Salivating) as dominant at a specific time, i.e. the dominance rate. The frequency of selection of each attribute as dominant by all subjects is represented in percentage (Axis Y) and evolves over the 600s period (Axis X). The curve showed over time the attributes considered as dominant at a panel level. An attribute was considered as not significantly dominant when the number of scoring was below P0 and significantly dominant when the number of scoring was above Pt with P0 and Pt as defined below:

$$\begin{matrix}Po = 1 / k ( k is the number of attributes ) . \\ {P}_{t} = {P}_{0} + 1.64 \sqrt{\frac{{P}_{0} ( 1 - {P}_{0} )}{n}}\end{matrix}$$

n is the number of subjects and the 1.64 is normal law z value for =5% (one-tailed).

Referring to FIG. 1 it can be seen that the Szechuan extract alone in water induces first a salivating perception and then a tingling perception with a maximum intensity at 200s a tingling perception.

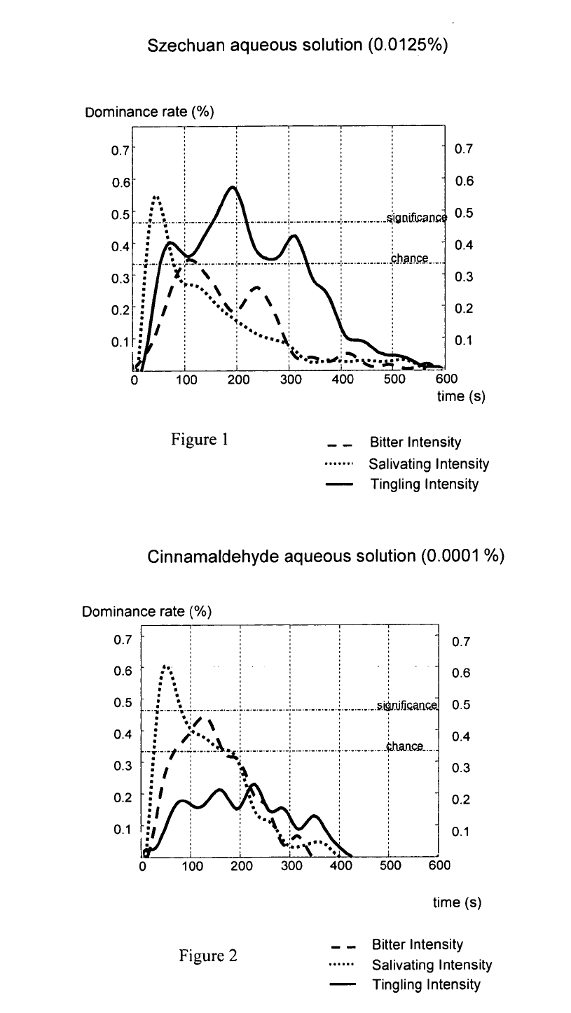

Referring to FIG. 2 it can be seen that the cinnamaldehyde alone did not induced a significant tingling perception.

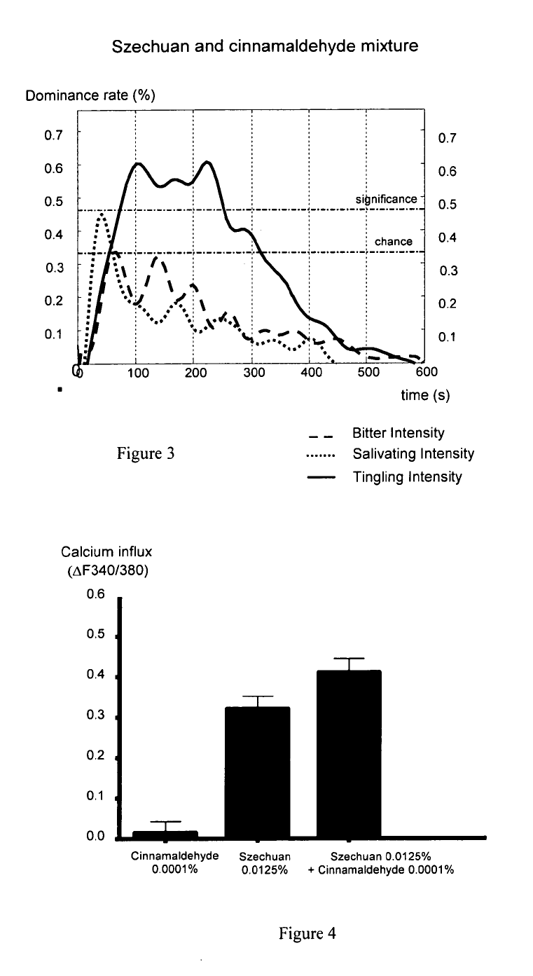

Referring to FIG. 3, it can be seen that a combination provides a synergistic effect, which provides the present composition with a longer-lasting, more intense tingling effect.

Referring to FIG. 4, it can be seen that the synergistic effect between Sichuan and cinnamaldehyde with a ratio of 1:0.008 was highlighted at a receptor level.

Thus, without wishing to be bound by theory, it is thought that the mechanism of the invention is based on a synergistic effect between Sichuan pepper extract and cinnamaldehyde at the receptor level.

Thus a tingling composition comprising Sichuan pepper extract and cinnamaldehyde present in a ratio of 1:0.005 to 1:0.01, more preferably 1:0.008, forms part of the present invention.

The composition of the present invention does not aim at imparting a flavour, odour or taste, when used in a food application but more at triggering tingling trigeminal perception.

The tingling trigeminal composition of the invention may thus be advantageously used in any types of foods or food compositions such as milk based dessert, confectionery, food “additives” such as spice mixes, sauces, dressings etc. When used in food applications, the tingling composition of the invention is preferably used such as to not undergo any harsh processes in order to preserve its properties.

A further advantage of the present tingling trigeminal composition is that it comprises natural compounds and can thus be further used in the manufacture of all-natural food products.

According to a preferred embodiment of the invention, the tingling trigeminal composition is used in the manufacture of frozen food products. Said frozen food products may be preferably selected from ice cream, sorbet, mellorine, sherbet, milk ice or water ice. Most preferably, the frozen food product is a water ice.

According to another embodiment of the invention, the tingling composition is used in the manufacture of chilled dairy products including but not limited to fermented or non-fermented milk-based products, wherein milk is meant as fresh or reconstituted animal milk, or alternatively as vegetable-based milk such as for instance juice obtained from soy, nut, hazelnut, almond etc.

The tingling composition of the invention can also be used in fermented or non-fermented aqueous, fruit, cereal or vegetal-based products, including but not limited to gels, purées, mousses, smoothies, porridges, fermented cereals, creams and soy yoghurts.

When used in frozen food products or dairy products, the tingling trigeminal composition is preferably present in an amount up to 0.005-0.02%, more preferably 0.0125% by weight of the product on a dry matter basis. This presents the advantage that a much smaller quantity of tingling composition is used compared to the amount of traditional tingling agent normally used in such products. Indeed, at least a five-fold reduction of the quantity of tingling composition can be achieved with the present invention.

Cinnamaldehyde is preferably present in an amount lower or equal to 0.0001% by weight of the product so that it does not impart any taste or olfactory perception to the latter.

The present frozen products are thus provided with an intense and longer lasting refreshing perception upon consumption.

A method for producing a tingling trigeminal composition falls under a further aspect of the invention. The method involves in a first step providing a Sichuan pepper extract. The extract can be bought commercially. Alternatively, it may be prepared by grinding the dried Sichuan pepper fruit, sieving the ground product to remove the fruit peal, immersing the ground product in water, decocting the suspension for about 10 min and filtering to give a final extract.

The Sichuan pepper extract is then mixed in a solution of cinnamaldehyde. The amount of Sichuan pepper extract in the final flavour composition is about 0.005-0.02%, preferably 0.0125%. The amount of cinnamaldehyde in the final trigeminal composition is about 0.00005-0.00015%, preferably 0.00010%. Preferably the solution comprises emulsifiers. The solution is also preferably an aqueous solution. The emulsifiers may be any food-grade emulsifier known in the art and are used to provide a homogeneous solution of both tingling agents.

In summary, the present invention provides a new way in which an all-natural tingling trigeminal composition can be produced. The composition further confers to the products to which it is added an intense and long-lasting refreshing perception.

The present invention is further illustrated hereinafter with the following non-limiting examples.

### EXAMPLES

### Example 1

A typical water ice composition according to the present invention is given in the table below.

| | Amount (g) |
|---|---|
| | per 100 g of |
| Ingredients | Water Ice |
| Stabiliser | 0.25 |
| Colouring | 0.001 |
| Sugars | 20-25 |
| Szechuan | 0.0125 |
| Cinnamaldehyde | 0.0001 |
| Emulsifier | 0.04 |
| Water | 75-80 |
| Flavouring | 0.05 |

### Example 2

A typical chocolate mousse composition according to the present invention is given in the table below.

| | Amount (g) |
|---|---|
| | per 100 g of |
| Ingredients | mousse |
| Fresh milk 4% fat | 69.7389 |
| Sugar | 11.6620 |
| Milk Chocolate | 7.0000 |
| Cacao Powder | 5.0000 |
| Milk cream 40% fat | 4.0000 |
| Skimmed milk powder | 1.0000 |
| Gelatin | 0.7000 |
| Emulsifier | 0.4080 |
| CMC | 0.4000 |
| Carrageenan | 0.0810 |
| Szechuan | 0.0100 |
| Cinnamaldehyde | 0.0001 |

### Example 3

A typical healthy fruit drink composition according to the present invention is given in the table below.

| | Amount (g) |
|---|---|
| | per 100 g of |
| Ingredients | drink |
| Water | 59.9799 |
| Banana pure | 28.0000 |
| Apple juice | 7.5500 |
| concentrate | |
| Red Fruit | 2.4600 |
| concentrate | |
| Orange juice | 2.0000 |
| concentrate | |
| Szechuan | 0.0100 |
| Cinnamaldehyde | 0.0001 |

### Example 4

A typical drinkable gel composition according to the present invention is given in the table below.

| | Amount (g) |
|---|---|
| | per 100 g of |
| Ingredients | drink |
| Water | 88.6099 |
| White Sugar | 10.0000 |
| Pectin | 1.2000 |
| Citric acid | 0.1800 |
| Szechuan | 0.0100 |
| Cinnamaldehyde | 0.0001 |

### Example 5

A typical drinkable yoghurt composition according to the present invention is given in the table below.

| | Amount (g) |
|---|---|
| | per 100 g of |
| Ingredients | drink |
| Water | 49.3299 |
| Milk 0.5% fat | 38.6700 |
| White Sugar | 9.8700 |
| Milk cream 40% fat | 1.3300 |
| Pectin | 0.5800 |
| Citric acid | 0.1100 |
| Flavouring | 0.1000 |
| Szechuan | 0.0100 |
| Cinnamaldehyde | 0.0001 |

1. Tingling trigeminal composition comprising Sichuan pepper extract and cinnamaldehyde, the Sichuan pepper extract and cinnamaldehyde being present in a ratio of 1:0.005 to 1:0.01.

2. Frozen food or chilled dairy composition comprising tingling trigeminal composition comprising Sichuan pepper extract and cinnamaldehyde, the Sichuan pepper extract and cinnamaldehyde being present in a ratio of 1:0.005 to 1:0.01.

3. Frozen food or chilled dairy composition according to claim 2, wherein the tingling trigeminal composition is present in an amount up to 0.005-0.02% by weight of the product on a dry matter basis.

4. Frozen food composition according to claim 2, wherein the composition is selected from the group consisting of ice cream, mellorine, sorbet, milk shake, sherbet, milk ice and water ice.

5. Frozen food composition according to claim 2, wherein the composition is a water ice.

6. A method of producing a tingling trigeminal composition comprising using Sichuan pepper extract and cinnamaldehyde to produce the composition.

7. Method for the production of a tingling trigeminal composition comprising the steps of
providing a Sichuan pepper extract; and
mixing the Sichuan pepper extract in a solution of cinnamaldehyde.

8. Method according to claim 7, wherein the amount of Sichuan pepper extract is 0.5-1.5% by weight of the total tingling trigeminal composition.

9. Method according to claim 7, wherein the amount of cinnamaldehyde is 0.0005-0.0015% of the total tingling trigeminal composition by weight.

10. Method according to claim 7, wherein the solution of cinnamaldehyde comprises emulsifiers.

11. Tingling trigeminal composition according to claim 1, wherein the ratio is 1:0.008.

12. Frozen food or chilled dairy composition according to claim 3, wherein the tingling trigeminal composition is present in an amount of up to 0.01% by weight of the product on a dry matter basis.
